(19) United States
(12) Patent Application Publication
(10) Pub. No.: US 2026/0201240 A1
(43) Pub. Date: Jul. 16, 2026

(54) Method of Remediating a Well for Long Term Production

(71) Applicant: Baker Hughes Oilfield Operations LLC, Houston, TX (US)

(72) Inventors: Naima Bestaoui-Spurr, The Woodlands, TX (US); Kimberly Spurlock-Lant, Conroe, TX (US); Xiaolan Wang, Spring, TX (US); Julio R Gomez, Cypress, TX (US); Billy Gray, Houston, TX (US)

(73) Assignee: Baker Hughes Oilfield Operations LLC, Houston, TX (US)

(21) Appl. No.: 19/359,578

(22) Filed: Oct. 15, 2025

Related U.S. Application Data
(63) Continuation-in-part of application No. 19/015,320, filed on Jan. 9, 2025, now Pat. No. 12,466,986.
Application No. 19/015,320 is a division of application No. 18/198,116, filed on May 16, 2023, now Pat. No. 12,234,406.

(51) Int. Cl. C09K 8/506; E21B 43/16

(52) U.S. Cl. CPC C09K 8/506; E21B 43/16; C09K 2208/10

(57) ABSTRACT

A well may be remediated by restoring or increasing production of the well by pumping into the well a carrier fluid having surface modified hydroxy containing nanoparticles, wherein the carrier fluid contains an alcohol, brine and a mutual solvent.

### SPECIFICATION

This application is a continuation-in-part application of U.S. patent application Ser. No. 19/015,320, filed on Jan. 9, 2025, which is a divisional of U.S. patent application Ser. No. 18/198,116 filed on May 16, 2023, which issued as U.S. Pat. No. 12,234,406 on Feb. 25, 2025, all of which are incorporated by reference.

### FIELD

The disclosure relates to methods of remediating a well having been partially or completely blocked by contaminants, accumulated or accumulated condensate by pumping into the formation hydrophobically and/or oleophobically surface modified hydroxy containing nanoparticles wherein the modified nanoparticles are in a carrier fluid; the carrier fluid being an alcohol/brine mixture with, optionally, a mutual solvent.

### BACKGROUND

Fluids produced from wells typically contain a complex mixture of components including aliphatic hydrocarbons, aromatics, hetero-atomic molecules, anionic salts, cationic salts, sulfides, acids, sands, silts and clays. The nature of these fluids combined with the severe conditions of heat, pressure, and turbulence to which they are often subjected, are contributory factors to the formation of scales. Scales are further commonly formed in produced water which contains high concentrations of alkaline earth metal cations such as calcium, strontium, iron and barium, along with anions such as carbonate, bicarbonate, sulfide sulfate. Further, scales may form from interaction of anions with the metals of brine. For instance, zinc sulfide and iron sulfide scales may form by interaction of hydrogen sulfide gas or a sulfur-containing chemical and a zinc-based brine.

Scale deposits are especially known to form near the wellbore, inside casing, tubing, pipes, the annular space between production tubing and casing, pumps, valves, heating coils as well as onto surfaces within the well including recovery equipment. The formation and deposition of scales is known to obstruct or restrict the flow of fluids (such as oil, gas, water or other production fluids) from the reservoir to the surface. Such obstructions decrease permeability of the reservoir penetrated by the well, reduce well productivity, restrict fluid flow in piping, reduce perforation tunnel diameter, reduce production tubing diameter and plug the flow path within the reservoir. Fluid restrictions (and in some cases blockage) become particularly acute as scales accumulate. In addition to reducing fluid flow and heat transfer, scale accumulates increase energy and operational costs due to additional pumping. Over time the lifetime of production equipment is shortened and the decrease in production rate attributable to scale deposits may force a halt in hydrocarbon recovery from the well. Further, the presence of scales in the annulus may make it difficult or impossible to remove the tubing for servicing.

Removal of scales often requires expensive well interventions involving mechanical devices such as scrapers, reamers, wire lines and coil tubing. Such remedial techniques are only useful if the devices can effectively reach the target location. Even then they have limited effectiveness when the tubular being treated is deviated, as in a horizontal well or “S” shaped configuration. The flexibility of mechanical tools makes it difficult to push a long distance past a severe deviation or multiple deviations.

Other known methods for scale removal are premised on the delivery of chemical treatment agents to affected areas. Such methods often require hydrocarbon production to be put into abeyance. For example, in downhole squeezing a slug of scale removal agent in a fluid is injected into the annulus as a pre-flush, squeeze or over flush fluid before the well can be returned to normal function. This technique further requires large volumes of treatment and flush fluid and is often limited to water-soluble scale removers.

U.S. Pat. Nos. 7,491,682; 7,598,209; 7,493,955; 9,010,430; 9,029,300; and 9,656,237 disclose methods of delivering water-soluble scale removing treatment agents into the well wherein the treatment agent is a component of a composite. The treatment agent may be released from the composite into the environs. A principal disadvantage of such methods is the difficulty in releasing the well treatment agent into the well over a sustained period. As a result, treatments must repeatedly be undertaken to ensure that the requisite level of treatment agent is continuously present in the well. Such treatments result in lost production revenue due to downtime.

Conventional methods of delivering well treatment agents into the well are further hampered when the scale treatment agent is oil-soluble. Since they are insoluble in water, such inhibitors are typically introduced into the well in an oil-based slug or slurry. The highly viscous nature of oil-soluble treatment agents restricts the amount of the treatment agent that can be delivered in a slug or slurry. In addition, such methods are typically not effective in the treatment of high-temperature wells.

The need for alternative methods for scale removal and prevention of fluid blockage has sharpened in today's market as operators continuously drill significantly deeper into wells to access hydrocarbon bearing formations.

It should be understood that the above-described discussion is provided for illustrative purposes only and is not intended to limit the scope or subject matter of the appended claims or those of any related patent application or patent.

### SUMMARY

Production of a well having been partially or completely blocked by contaminants, accumulated water or accumulated condensate may be restored or increased by pumping into the well surface modified hydroxy containing nanoparticles in a carrier fluid. The carrier fluid may be composed of (i) an alcohol selected from the group consisting of methanol, ethanol, propyl alcohol, isopropyl alcohol, butanol, iso-butanol and mixtures thereof; (ii) a brine selected from the group consisting of sodium chloride, sodium bromide, potassium chloride, potassium bromide, ammonium chloride, ammonium bromide and mixtures thereof; and/or (iii) a mutual solvent such as glycol ethers or esters. The hydroxy containing nanoparticles are surface modified with a surface modifying treatment agent composed of (i) an anchor selected from the group consisting of aluminum, silicon and a transition metal; and (ii) one or more hydrophobic and/or oleophobic moieties attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer or perfluoroalkylene ether.

In another embodiment, a well penetrating a subterranean formation in which flow of fluids from the formation to the well has been restricted or obstructed by contaminants, accumulated water or accumulated condensate may be remediated by pumping surface modified hydroxy containing nanoparticles in a carrier fluid into the well. The carrier fluid may be composed of at least one of (i) an alcohol selected from the group consisting of methanol, ethanol, propyl alcohol, isopropyl alcohol, butanol, iso-butanol and mixtures thereof; (ii) a brine selected from the group consisting of sodium chloride, sodium bromide, potassium chloride, potassium bromide, ammonium chloride, ammonium bromide and mixtures thereof; and (iii) a mutual solvent. The surface modified hydroxy containing nanoparticles are surface modified with a surface modifying treatment agent of the structure ZₘX(OR)ₙ wherein X is an anchor selected from the group consisting of aluminum, silicon and a transition metal; Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer, or perfluoroalkylene ether; each R being independently selected from a branched or unbranched C₁-C₂₀ alkyl or aryl group; m+n is defined by the valence state of the anchor provided neither m nor n are zero. The surface modified hydroxy containing nanoparticles are attached onto the surface of the formation wherein the hydrophobic and/or oleophobic functional groups are imparted away from the surface of the formation.

In another embodiment, a method of restoring or increasing production of a well having flowpaths partially or completely obstructed or blocked by contaminants, accumulated water or accumulated condensate is provided. In this method, hydroxy containing surface modified nanoparticles in a carrier fluid is pumped into the well. The carrier fluid comprises at least (i) an alcohol selected from the group consisting of methanol, ethanol, propyl alcohol, isopropyl alcohol, butanol, iso-butanol and mixtures thereof; (ii) a brine consisting of sodium chloride, sodium bromide, potassium chloride, potassium bromide, ammonium chloride, ammonium bromide and mixture thereof; and/or (iii) a mutual solvent. The nanoparticles, onto which one or more hydroxyl groups are attached, may be silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, iron oxide, fullerenes, nanoclays, nanotubes, graphenes like nanographite, nanodots, nanorods, nanodiamonds, polysilsesquioxanes, antimony oxide, vanadium oxide, magnesium oxide, metal or metalloid carbides, and mixtures thereof. The nanoparticles have one or more hydroxyl groups and are surface modified with a surface modifying treatment agent of the structure ZₘX(OR)ₙ wherein X is an anchor selected from the group consisting of aluminum, silicon and a transition metal; Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer or perfluoroalkylene ether; each R being independently selected from a branched or unbranched C₁-C₂₀ alkyl or aryl group; m+n is defined by the valence state of the anchor provided neither m nor n are zero.

In another embodiment, the surface modifying treatment agent referenced in the paragraphs above may be altered by substitution of at least one of the —OR groups with a substituted or unsubstituted C₁-C₈ modified glycol having the hydroxy group on one end of the glycol modified with —OB, wherein B is C₁-C₂₀ branched or unbranched alkyl group or an aryl group.

Characteristics and advantages of the present disclosure described above, and additional features and benefits will be readily apparent to those skilled in the art upon consideration of the following detailed description of various embodiments and referring to the accompanying drawings.

### DRAWINGS

The following figures are part of the present specification, included to demonstrate certain aspects of various embodiments of this disclosure and referenced in the detailed description wherein:

FIG. 1 illustrates a method of remediating a well by pumping surface modified hydroxy containing nanoparticles into a well and attaching the surface modified hydroxy containing nanoparticles to a surface of a subterranean formation.

FIG. 2 illustrates a method of remediating a well by pumping into the well surface modified hydroxy containing nanoparticles which have been altered with a linking agent containing a blocking moiety.

FIGS. 3 and 4 illustrate the hydrophobicity imparted by a fluid having the carrier as defined herein on a surface exposed to water and oil, respectively.

FIG. 5 illustrates the increased permeability of sandstone treated with a fluid containing the carrier fluid as defined herein.

FIG. 6 illustrates the effect of a surface modified hydroxy nanoparticles on gas condensate.

### DETAILED DESCRIPTION

References herein and in the appended claims to components and aspects in a singular tense does not necessarily limit the present disclosure or appended claims to only one such component or aspect, but should be interpreted generally to mean one or more, as may be suitable and desirable in each particular instance. The suffix “(s)” as used herein is intended to include both the singular and the plural of the term that it modifies, thereby including at least one of that term. The use of the terms “a” and “an” and “the” and similar referents in the context of describing the invention (especially in the context of the following claims) are to be construed to cover both the singular and the plural, unless otherwise indicated herein or clearly contradicted by context.

All ranges disclosed herein are inclusive of the endpoints. A numerical range having a lower endpoint and an upper endpoint shall further encompass any number and any range falling within the lower endpoint and the upper endpoint. For example, every range of values (in the form “from a to b” or “from about a to about b” or “from about a to b,” “from approximately a to b,” “between about a and about b,” and any similar expressions, where “a” and “b” represent numerical values of degree or measurement is to be understood to set forth every number and range encompassed within the broader range of values and inclusive of the endpoints.

All references are incorporated herein by reference.

The disclosure relates to methods of remediating a well where flow of fluids from the formation have been restricted, obstructed or blocked. Such restrictions are typically the resultant of the accumulation of scales. Other accumulated contaminants may also contribute to reducing fluid flow including the formation of hydrates, paraffin or wax deposits and the deposition of asphaltenes. Further, blockage or restriction of fluid flow may be the resultant of accumulated water or accumulated condensate within the well.

The well may be remediated by the introduction of surface modified hydroxy containing nanoparticles in a carrier fluid. Typically, the amount of surface modified hydroxy containing nanoparticles in the carrier fluid is from about 0.01 to about 50, more typically from about 0.1 to about 20%, weight percent.

The carrier fluid contains a brine and an alcohol and optionally, a mutual solvent. In an embodiment, the amount of brine in the carrier fluid is from about 10 to about 60, more typically from about 40 to 55, weight percent; the amount of alcohol in the carrier fluid is from about 5 to about 90, more typically from about 20 to about 30, weight percent; and the amount of mutual solvent, when present, is an amount from about 5 to about 90, more typically from about 20 to about 40, weight percent/v.

The brine may be a sodium chloride, sodium bromide, potassium chloride, potassium bromide, ammonium chloride or ammonium bromide brine as well as mixtures thereof. Typically, the amount of salt in the brine is about 1 to about 5, more typically from about 2 to about 3, weight percent.

In an embodiment, the alcohol of the carrier fluid may be one selected from the group consisting of methanol, ethanol, propyl alcohol, isopropyl alcohol, butanol, iso-butanol and mixtures thereof.

In a preferred embodiment, the carrier fluid contains a mutual solvent. Typically, the mutual solvent is a chemically mutually soluble solvent in hydrocarbons and water. Mutual solvents, among other things, may act to remove hydrocarbons adhering to formation material. Acceptable mutual solvents include glycol ethers or ethers, tetrahydrofuran, dioxane, dimethylformamide, dimethylsulfoxide and mixtures thereof. In a preferred embodiment, the mutual solvent is a glycol ether such as ethyleneglycolmonobutyl ether (EGMBE), dipropylene glycol monomethyl ether and mixtures thereof. When present, the amount of mutual solvent in the carrier fluid is between 5 to 90 volume percent.

In some instances, the flash point of the carrier fluid may be from about 50° F. to about 135° F., more typically from about 90° F. to about 120° F.

The hydrophobic nature of the surface modified hydroxy containing nanoparticles in the carrier fluid may serve to control condensation in the pores of a near wellbore region of a permeable formation. Often, a liquid zone is formed from the condensation of hydrocarbons within a gas reservoir close to the wellbore which hampers gas flow. This creates “water block” or “water bank” zones, thereby reducing productivity. The surface modified hydroxy containing nanoparticles increases the relative permeability of the formation to oil and/or gas with respect to water, oil and/or condensate, thus preventing water banking within the formation. In some instances, condensate block and/or accumulated water formed in the pores may be decreased or removed by pumping of the surface modified hydroxy containing nanoparticles in the defined carrier fluid. By minimizing the formation of or removing condensate block and condensate dropout, fluid transfer and water flux through the pores of the near wellbore region of the formation may be effectively controlled.

Pumping of the surface modified hydroxy containing nanoparticles in carrier fluid finds particular applicability in the treatment of rich gas or retrograde condensate gas reservoirs and thus presents value to retrograde gas fields by minimizing condensate accumulation in pore throat. In such reservoirs, heavy end fraction of gases may be condensed in liquid form as the reservoir pressure within the well is decreased below the dew point of the gas. Condensed liquid drains downward by gravity when its saturation exceeds the irreducible condensate saturation. With retrograde gases, liquids cannot be reabsorbed into the gas phase even if pressure is increased by a rate reduction. When a well treatment fluid containing the surface modified hydroxy containing nanoparticles disclosed herein is pumped into a retrograde gas well, the permeability of the formation may be maintained, and condensate dropout minimized. Thus, in turn, minimizes the possibility of the formation of an emulsion between precipitated hydrocarbons and the invading water from the aqueous based well treatment fluid. The pressure below the dew point of the hydrocarbons may therefore be maintained. By enhancing the permeability of the formation to liquid hydrocarbons, loss of light condensate liquids is minimized, and light condensate liquids may therefore be more readily displaced.

Further, since the surface modifying treatment agent may be oleophobic, oil may further be produced more efficiently by use of the surface modified hydroxy containing nanoparticles.

In an embodiment, the combination of the surface modified hydroxy containing nanoparticles and carrier fluid may be used to control, prevent scale-up or remove scale deposition onto or within the formation. The surface modified hydroxy containing nanoparticles improves the permeability of the formation. As such, pumping of the surface modified hydroxy containing nanoparticles in the carrier fluid restores as well as increases production of hydrocarbons. Further, blockage from contaminants, accumulated water and/or accumulated oil and/or gas condensates is removed.

The hydrophobic nature of the surface modified hydroxy containing nanoparticles minimizes or decreases the ability of formed condensate adhering to the formation. In an embodiment, the non-wetting nature of the surface modifying treatment agent attached to the hydroxy containing nanoparticles may be imparted away from the surface of the formation and thus are exposed to hydrocarbon forming fluids as well as aqueous formation fluids. The surface modifying treatment agent thus modifies a hydrophilic (formation) surfaces to be hydrophobic and/or oleophobic. In doing so, bonding of the nanoparticles with the surface modifying treatment agent minimizes the binding sites for scales as well as other unwanted particulates. Further, the bulky nature of the surface modifying treatment agent prevents or controls deposition of scales onto or within the formation surface.

The surface modified hydroxy containing nanoparticles are particularly effective in the treatment of inorganic scales, such as calcium, barium, magnesium salts and the like including barium sulfate, calcium sulfate, and calcium carbonate scales as well as metal sulfide scales, like zinc sulfide, iron sulfide, etc. Such scales can precipitate from produced water and create blockages in flow paths within the formation. Such scales tend to plug pore spaces, reduce porosity and decrease permeability of the formation, reduce well productivity and, in some cases, may completely block well tubings.

The amount of scales, water block and/or condensate block removed by the presence of the surface modified hydroxy containing nanoparticles in the defined carrier fluid is dramatically increased compared to the pumping of the surface modified hydroxy containing nanoparticles using a carrier fluid containing only alcohol and brine. In most instances, the amount of scales, water block and/or condensate block removed is 40%, and in some instances, 60%, greater than those removed using a carrier fluid containing only the alcohol and brine.

The subterranean formation, onto which the surface modified hydroxy containing nanoparticles is bond, may be a siliceous formation, such as sandstone, as well as a metal oxide containing formation or a carbonate formation. The formation may be enriched in clay, and the metal may include alumina.

In an embodiment, the surface of the subterranean formation may be first modified to have a positive or negative charge prior to pumping the surface modified hydroxy containing nanoparticles into the formation or onto the formation surface. This is usually desired when the surface of the formation does not contain free —OH groups. (Surfaces of substrates like silica and alumina may also have exposed hydroxyl groups.) The surface of the nanoparticles may also be charged, if desired. Such a modification provides a higher likelihood of adhesion or binding of the surface modified hydroxy containing nanoparticles to the hydrophilic surface. This may be unnecessary in some instances where surfaces of the formation have exposed hydroxy groups or silicon-oxo or the aluminum-oxo linkages.

A surface modifying hydroxy containing nanoparticle may contain a nanoparticle as core having attached one or more hydroxy groups. In addition, one or more surface modifying treatment agents (which are typically hydrophobic and/or oleophobic organic groups) are attached to the nanoparticle. The surface modifying hydroxy containing nanoparticle may be exemplified as:

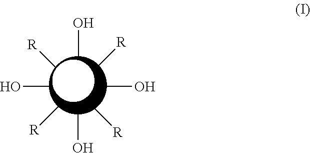

where R is the surface modifying treatment agent. As shown, there are three surface modifying treatment agents attached to the nanoparticle (as core) as well as three hydroxy groups. However, the maximum number of groups of surface modifying treatment agents and hydroxy groups on the nanoparticle may be sufficient to avoid steric hindrance. Typically, the ratio of hydroxy to surface modifying groups on the nanoparticle will be from about 1:40 to about 40:1.

In an embodiment the surface modified hydroxy containing nanoparticles alter or modify hydrophilic surfaces of a subterranean formation into a hydrophobic and/or oleophobic surface. Thus, production of hydrocarbons from a subterranean formation are enhanced by altering the treatment of the surface of the formation with the surface modified hydroxy containing nanoparticles. Relative permeability of the formation is improved as well.

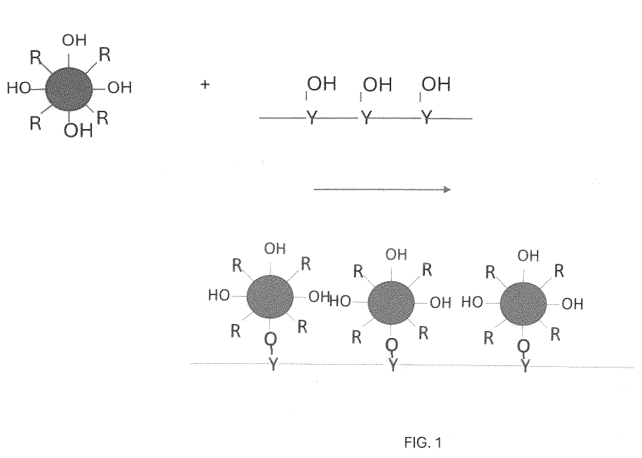

Typically, the surface modified hydroxy containing nanoparticles of (I) are first prepared which are then pumped into the well. FIG. 1 shows the pumping of surface modified hydroxy containing nanoparticles reacting with multiple-OH groups of the formation. The surface modified hydroxy containing nanoparticles are illustrated as being directly attached on the surface of the formation through a condensation reaction. Further, the surface modifying treatment agent on the surface modified hydroxy containing nanoparticles are shown as being aligned such that the hydrophobic and/or oleophobic moieties are directed away from the surface of the formation. FIG. 1 shows three molecules of surface modifying treatment agents of (II) being attached to a single nanoparticle. Each R may have anchor, M, attached to the surface of the nanoparticle(s). [In such instances, the formula (II) may be best represented as Zₘ₋₁X(OR)ₙ. where Z, X, R, m and n are as defined above.]

In an alternative embodiment, the hydrophobic and/or oleophobic surface modifying treatment agent(s) may be pumped into the well before or after pumping a second fluid into the well containing the surface modified hydroxy containing nanoparticles. Thus, the surface modified hydroxy containing nanoparticles may be formed in-situ by attachment of the hydrophobic and/or oleophobic surface modifying treatment agent to the nanoparticles.

In another embodiment, the hydroxy containing nanoparticles may be first attached to the formation surface, and the nanoparticles may then be functionalized with the surface modifying treatment agent.

Attachment of the surface modified hydroxy containing nanoparticles to the surface of the formation to render the surface hydrophobic and/or oleophobic may alter the surface energy of the formation being treated. Typically, use of the surface modified hydroxy containing nanoparticles for attachment to the surface makes the surface of the formation more rough (or less smooth). Low surface energy is imparted to the surface by the presence of the surface modifying treatment agent attached to the hydroxy containing nanoparticles as well as the nanostructuration on the surface of the rock. The result is the in-situ functionalization of the surface of the formation, and the method may be viewed as a procedure for mimicking the Lotus effect, a treatment phenomenon, downhole. The Lotus effect requires surface roughness and a low surface energy component. The hydrophobic and/or oleophobic surface hydroxy containing nanoparticles alter (lower) the surface energy of the formation. Functionalization of the surface of the formation with the surface modified hydroxy containing nanoparticles permanently and positively affects the movement of fluids through the formation while decreasing water saturation. Conductivity of the formation to water and oil is improved.

Suitable nanoparticles include inorganic nanoparticles such as a metal or metalloid oxide or hydroxide like silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide or iron oxide as well as a metal or metalloid carbide like tungsten carbide, silicon carbide and boron carbide and metal or metalloid nitrides like titanium nitride, boron nitride and silicon nitride or a combination thereof. Metal nanoparticles include alkali metals, alkaline earth metals, inner transition metals (a lanthanide or actinide), a transition metal, or a post-transition metal. Examples of such metals include magnesium, aluminum, iron, tin, titanium, platinum, palladium, cobalt, nickel, vanadium, chromium, manganese, zirconium, ruthenium, hafnium, tantalum, tungsten, rhenium, osmium, alloys thereof as well as barium or strontium titanate or a combination thereof. Preferred nanoparticles include alumina, boehmite and zirconia.

Other suitable nanoparticles include fullerenes, nanotubes, graphenes like nanographite, nanodots, nanorods, nanodiamonds, polysilsesquioxanes, antimony oxide, vanadium oxide and magnesium oxide and mixtures thereof.

Fullerenes include cage-like hollow polyhedral allotropic carbon forms possessing a polyhedral structure and include those having from about 20 to about 100 carbon atoms.

Nanographites may be represented as clusters of plate-like sheets of graphite having a stacked structure of one or more layers of graphite of plate-like two-dimensional structures of fused hexagonal rings

Suitable graphenes including nanographene and graphene fibers (graphene particles having an average largest dimension of greater than 1 μm, a second dimension of less than 1 μm, and an aspect ratio of greater than 10, where the graphene particles form an interbonded chain). The graphene and nanographene fibers are effectively two-dimensional particles having more than one layer of fused hexagonal rings. Typically, the graphene nanoparticles may be prepared by exfoliation of a graphite source such as nanographite, graphene or nanographene, graphite and intercalated graphite. Exemplary exfoliation methods include fluorination, acid intercalation as well as acid intercalation followed by high temperature treatment. Exfoliation of the nanographite provides a nanographene having fewer layers than non-exfoliated nanographite. Exfoliation of nanographite may provide the nanographene as a single sheet only one molecule thick, or as a layered stack of sheets. In an embodiment, the exfoliated nanographene may have fewer than 50 single sheet layers and in another embodiment fewer than 5 single sheet layers.

Suitable nanotubes include carbon nanotubes, inorganic nanotubes (e.g., boron nitride nanotubes), metallated nanotubes or a combination thereof. Suitable nanotubes include single walled nanotubes (SWNTs) or multi-walled nanotubes (MWNTs).

Suitable polysilsesquioxanes (also referred to as polyorganosilsesquioxanes or polyhedral oligomeric silsesquioxanes (POSS) derivatives) are polyorganosilicon oxide compounds of general formula RSiO_{1.5} (where R is an organic group such as methyl) having defined closed or open cage structures (closo or nido structures). Polysilsesquioxanes, including POSS structures, may be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

In addition, the nanoparticles may further be nano-layered silicates or nanoclays (hydrated or anhydrous silicate, plate-like minerals with a layered structure). Exemplary nanoclays include aluminosilicate clays like kaolins (including vermiculite), hallyosite, bentonite, smectites (including montmorillonite), saponite, beidellite, nontrite, hectorite, alllophane and illite as well as titanium sulfate and zirconium sulfate. The nanoclays may be exfoliated to separate individual sheets, or non-exfoliated. Other nanosized mineral fillers of similar structure which may be used include talc, micas including muscovite, phlogopite or phengite. Platelets of the nanoclay typically have a thickness of about 3 to about 1000 Angstroms, a size in the planar direction ranging from about 0.01 μm to 100 μm and a specific surface area in from about 90 to about 800 m²/g. The aspect ratio (length versus thickness) is generally in the order of about 10 to about 10,000.

Further, the nanoparticles may be derivatized to include a variety of different functional groups such as, for example, carboxy (e.g., carboxylic acid and anhydride groups like maleic anhydride), epoxy, ether, ketone, amine, hydroxy, alkoxy, alkyl, aryl, aralkyl, alkaryl, lactone as well as functionalized polymeric or oligomeric groups. In an embodiment, the nanoparticles include a combination of derivatized nanoparticles and underivatized nanoparticles.

The nanoparticles may further be derivatized to include one or more functional groups that are hydrophilic, hydrophobic, oxophilic, lipophilic, or oleophilic. In an embodiment, such functional groups may include (i) organosilicon materials, (ii) fluorinated organic acids or a reactive derivative; (iii) linear or branched alkyl organic acids or a reactive derivative, (iv) substituted alkyl organic acids or a reactive derivative, (v) aryl or substituted aryl organic acids or a reactive derivative as well as (vi) mixtures thereof.

In an embodiment, the hydrophobic and/or oleophobic surface modifying treatment agent attached to the hydroxy containing nanoparticles may be fluorine-free. The green chemistry created by the attachment of such surface modifying treatment agents to the hydroxy containing nanoparticles provides an environmentally friendly alternative.

In an embodiment, the hydroxy containing nanoparticles may be modified with one or more surface modifying treatment agents of the formula:

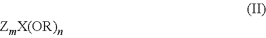

wherein anchor X is an anchor; and each Z is a hydrophobic and/or oleophobic moiety attached to the anchor and R is a C₁-C₂₀ branched or unbranched alkyl or aryl group. When Z contains a moiety which is both hydrophobic and oleophobic, the surface modifying treatment agent may be regarded as being omniphobic. The R groups may be of sufficient magnitude to increase steric hindrance around the anchor while maintaining the presence of the hydrophobic/oleophobic functional group(s). In those cases where the surface modifying treatment agent has more than one-OR group, the —R substituent may be the same or different. After being pumped into the well, a free-OH group on the surface modified hydroxy containing nanoparticle may undergo a condensation reaction with a free-Oh group on the formation surface.

In an embodiment, anchor, X, may be aluminum, silicon or a transition metal. Suitable transition metals include Group 3, 4, 5, or 6 metals. In an embodiment, the metal is a Group 4 metal, such as Ti, Zr or Hf, a Group 5 metal, such as Ta or Nb, a Group 6 metal, such as W, or a metal of the lanthanide series, such as La.

In formula (II), m+n is defined by the valence state of anchor X provided neither m nor n are zero. For instance, where the valence state of anchor X is 4 (such as is Si or Ti⁴⁺), m and n are from 1 to 3 and m+n is 4; where the valence state of anchor X is 3 (such as Zr³⁺ or Al³⁺), m and n is 1 or 2 and m+n is 3.

The rate of hydrolysis of the surface modified hydroxy containing nanoparticles at the surface of the formation decreases as the size of groups R and Z increase. In other words, as the R groups of (II) become larger and branched, the rate of hydrolysis at the surface of the formation may be slower.

In an embodiment, the hydrophobic/oleophobic group is a hydrocarbon (such as an alkyl, aryl, substituted alkyl or substituted aryl group). In an embodiment, the hydrophobic/oleophobic tail is substantially free of branching, or halogenated hydrocarbon chain which may be branched or unbranched. The hydrophobic/oleophobic group may be referred to a hydrophobic tail since it extends away from the formation. In an embodiment, the hydrophobic and/or oleophobic tail is a long hydrocarbon chain or long chain hydrocarbon halogenated (and most preferably fluorinated) chain. Suitable hydrophobic and/or oleophobic moieties contain from about 3 to about 40, typically 3 to about 20, preferably from about 6 to 14, sometimes more preferably from about 8 to about 10, carbon atoms. In an embodiment, Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer, or perfluoroalkylene ether group.

In an embodiment, the hydrophobic moiety and/or oleophobic moiety is a fluorinated ethylenically unsaturated monomer. Exemplary ethylenically unsaturated monomers are fluorinated acrylates and methacrylates such as perfluorohexyl methacrylate, perfluoroheptyl methacrylate, perfluorooctyl methacrylate, perfluorononyl perfluorodecyl methacrylate, perfluoroundecyl methacrylate or perfluorododecyl methacrylate.

In an embodiment, the hydrophobic and/or oleophobic moiety has at least one terminal trifluoromethyl group. For instance, the hydrophobic and/or oleophobic moiety may be a long chain hydrocarbon or fluorinated hydrocarbon, fluorinated acrylate or fluorinated (meth)acryalte containing one or more terminal trifluoromethyl group(s) and/or an ethylenically unsaturated monomer having one or more terminal trifluoromethyl groups. Exemplary of suitable fluorinated ethylenically unsaturated monomers having a terminal —CF₃ group include fluoroalkyl methacrylate monomers such as perfluorooctyl methacrylate having the chemical formula C₇F₁₅CH₂OCOC(CH₃)═CH₂.

The hydrophobic and/or oleophobic moiety may be polymeric; preferably, having a number average molecular weight of less than 2000.

Suitable monomers which may be polymerized include any of the halogenated (preferably fluorinated) long chain hydrocarbons referenced herein and one or more ethylenically unsaturated monomers. Suitable ethylenically unsaturated monomers include hexyl ethylenically unsaturated monomers, heptyl ethylenically unsaturated monomers, octyl ethylenically unsaturated monomers, nonyl ethylenically unsaturated monomers, decyl ethylenically unsaturated monomers, undecyl ethylenically unsaturated monomers, and dodecyl ethylenically unsaturated monomers as well as mixtures thereof. Such monomers may be fluorinated. As such, the polymeric hydrophobic and/or oleophobic moiety may be derived from a fluorinated ethylenically unsaturated monomer with a non-halogenated or halogenated long chain hydrocarbon as recited herein.

In a preferred embodiment, the hydrophobic and/or oleophobic moiety is a polymerization product of a monomer having terminal trifluoromethyl groups including ethylenically unsaturated monomers such as any of the monomers referenced in the paragraph above. In an embodiment, the hydrophobic and/or oleophobic moiety is a fluoroalkyl or perfluoroalkyl ethylenically unsaturated monomer having a terminal trifluoromethyl group. In an embodiment, the blocking moiety is a trifluoromethyl terminated, substantially unbranched perfluorooctyl monomer, such as a perfluorinated iso-octyl monomer having two terminal trifluoromethyl groups. In another embodiment, the blocking moiety may be a product of a substantially non-branched perfluoroalkyl unsaturated monomers having terminal trifluoromethyl groups, including fluorinated or perfluorinated monomers.

In another embodiment, the hydrophobic functional group (bonded to the anchor) is a fluorine containing moiety, such as R_{f}—(CH₂)ₚ— where R_{f} is a perfluorinated alkyl group or a perfluorinated alkylene ether group and p is 2 to 4, preferably 2, or a perfluorinated hydrocarbon group including an oxygen substituted hydrocarbon group, such as a perfluorinated alkyl group or a perfluorinated alkylene ether group and p is 0 to 18, preferably 0 to 4, and X is a polar group such as a is carboxyl, like of the structure —(C—O)—OR; and R is hydrogen, perfluoroalkyl, alkyl or substituted alkyl containing from 1 to 50 carbon atoms, preferably from about 2 to about 20 carbon atoms in the alkyl group associated with the ester linkage.

Examples of perfluoroalkyl groups are those of the structure F—(CFY—CF₂)ₘ where Y is F or CₙF₂ₙ₊₁; m is 4 to 20 and n is 1 to 6.

Examples of perfluoroalkylene ether groups are those of the structure:

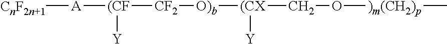

where A is an oxygen radical or a chemical bond such as CF₂; n is 1 to 20, preferably 1 to 6; Y is H, F, CₙH₂ₙ₊₁ or CₙF₂ₙ₊₁; b is at least 1, preferably 2 to 10, m is 0 to 50, and p is 1 to 20.

Preferred fluorinated materials are esters of perfluorinated alcohols such as the alcohols of the structure F—(CFY—CF₂)ₘ—CH₂—CH₂—OH where Y is F or CₙF₂ₙ₊₁; m is 4 to 20 and n is 1 to 6.

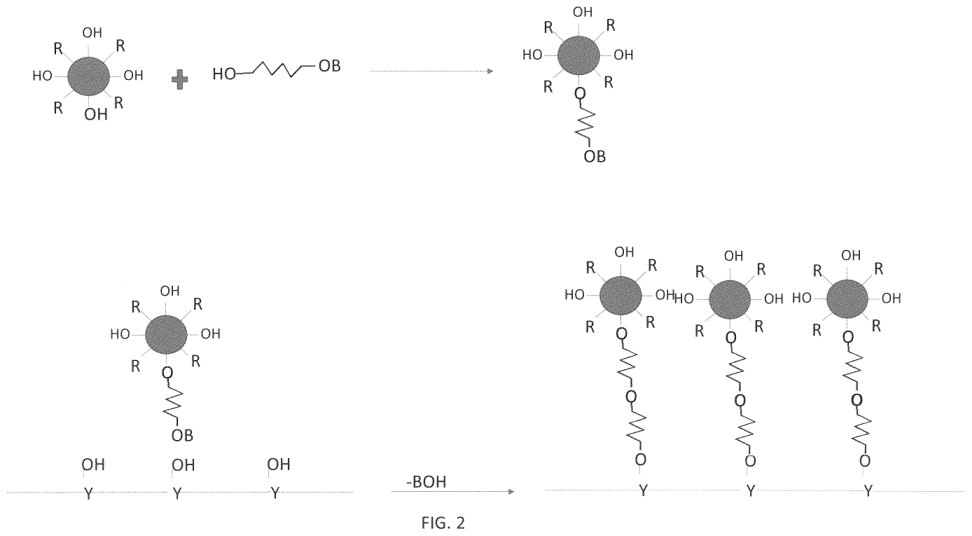

In an embodiment, the hydroxy containing surface modified nanoparticles may be altered with a bifunctional linking agent containing one or more blocking moieties, —OB, in place of one or more —OR moieties. FIG. 2 illustrates an exemplary method of forming altered surface modified hydroxy containing nanoparticles and attaching the altered nanoparticles onto the surface of a formation. As shown, reactive blocking moiety, —OB, is attached to the hydroxy containing surface modified nanoparticles by a bifunctional linking agent; the bifunctional linking agent being a modified glycol having a C₁-C₈ substituted or unsubstituted alkylene group and having the hydroxy group on one end of the glycol and the —B substituent at the other end.

In an embodiment, the linking agent is a glycolic substituent, typically containing 2 to 6 carbon atoms, like 1,4-butylene glycol or 1,6-hexane diol. Functional groups of the linking agent (shown as hydroxy groups in FIG. 2) alter the surface of the surface modified hydroxy containing nanoparticles such that they may more easily attach to the surface of the formation.

The bifunctional linking agent may further be a silane, siloxane, phosphonate or phosphonic acid. In an embodiment, the bifunctional linking agent may have, instead of the —OH terminal group, a —COOH or amino group at the other terminal end.

One or more molecules of the altered surface modified hydroxy containing nanoparticles may react with different hydroxy groups on the surface of the formation. Alternatively, a single molecule of surface modifying treatment agent having multiple blocking moieties may react with more than one free hydroxy group on the surface of the formation. Covalent bonds between the blocking moiety and a —OH group on the surface of the formation (or OH of a linking agent) may form on the surface of the formation (subject to restraints created through steric hindrance).

FIG. 2 shows three molecules of surface modifying treatment agents of (III) being attached to a formation. Each altered hydroxy containing surface modified treatment agents have anchor, M, attached to the surface of the nanoparticle(s).

Alternatively, a single molecule of altered surface modified hydroxy containing nanoparticles having multiple blocking moieties, —OB, may react with multiple free hydroxy groups on the surface of the formation. When not prohibited by steric hindrance, multiple condensation reactions may occur between-OH groups of the formation and the blocking moiety of a single altered surface modified hydroxy containing nanoparticle.

As shown in FIG. 2, the hydroxy groups of the linking agent form a covalent bond with free hydroxy groups of the nanoparticle through a condensation reaction. Upon being pumped, the —B substituent of the terminal-OB group reacts with a free-OH group on the surface of the formation and a condensation reaction product is formed between the altered surface modifying hydroxy containing nanoparticles and the formation; the B—OH being a leaving group formed between the —B moiety and free-OH group. The surface modified hydroxy containing nanoparticles are thereby directly linked to the surface of the formation.

The hydrophobic and/or oleophobic tail of the surface modifying treatment agent is then exposed to hydrocarbon fluids as well as aqueous fluids within the formation. Hydrophobicity is imparted to the hydrophilic surface of the formation by the hydrophobic tail and the covalent bond formed between the blocking moiety and surface hydroxy groups. The presence of the blocking moiety on the altered surface modified hydroxy containing nanoparticles may prevent undesired self-condensation.

The blocking moiety, as well as the hydrophobic and/or oleophobic moieties, are attached to the anchor. Where the surface modifying treatment agent of (III) has more than one-OB and/or hydrophobic/oleophobic functional groups, the functional groups may be the same or different. In other words, substituents for multiple-OB and/or hydrophobic/oleophobic functional groups may be independently selected from any of those recited herein.

The blocking moiety, —OB, controls and increases the stability of the surface modifying treatment agent in the presence of water. The blocking moiety typically consists of bulky hydrocarbons, as B, attached to an oxygen atom to form alkoxy groups. The presence of the —B group on the blocking moiety slows down or reduces reactivity of the X—O group of the surface modifying treatment agent.

Representative hydrocarbons such as B include a C₁-C₂₀ (typically a C₁-C₁₂) branched or unbranched alkyl (preferably C₁-C₈ alkyl group and more preferably a C₁-C₄ alkyl group) or an aryl group (preferably a phenyl or alkyl substituted phenyl group). Exemplary hydrocarbons include methyl, ethyl, propyl, butyl, —C(CH₃)₃; —(CH₂)₄—CH₃CH(CH₃)₂)₃ and phenyl. Generally, it is desirable for the blocking moiety to be of sufficient magnitude to increase steric hindrance around the anchor while maintaining the presence of the hydrophobic/oleophobic functional group(s). The rate of hydrolysis of the blocking moiety decreases as the size of the —B groups increase. In other words, as —B, is larger and branched, the rate of hydrolysis at the surface of the formation is slower.

Under in-situ conditions, a condensation product is formed on the surface of the formation from the reaction of a free hydroxy group which is (directly or indirectly) attached to the surface of the formation and the —B substituent of the blocking moiety, —OB, while the other terminal end of the bifunctional linking agent forms a condensation product with a —OH group attached to the nanoparticle modified with the surface modifying treatment agent. Unwanted self-condensation of the surface modifying treatment agent results from the presence of the blocking moiety.

Hydroxy containing surface modified nanoparticles, as well as altered hydroxy containing surface modified nanoparticles, pumped into the formation in any of the embodiments may be in the form of a dispersion wherein the dispersed size of the nanoparticles may range from about 1 to 1000 nm, 50 to about 500 nanometers in diameter, such as about 100 to about 250 nm. Further, the concentration of such nanoparticles in the pumped fluid may be greater than 0.5% (about 41.7 pounds per thousand gallons (“pptg”)) by weight based on the total weight of the fluid. For example, the concentration of nanoparticles can range from about 2% to about 20% by weight (about 167 pptg to about 1670 pptg).

In an embodiment, anchor X is-Si and the altered surface modifying treatment agent may be a silyl ether containing a silicon atom covalently bonded to three blocking moieties, —OB. Representative silyl ethers include those of formula SiOB¹OB²OB³ wherein B¹, B² and B³ independently represent a C₁-C₁₂ alkyl or aryl group (preferably C₁-C₈ alkyl group and more preferably a C₁-C₄ alkyl group). Preferred alkoxysilanes may be those which liberate methanol or ethanol; —ZOB defining the silane. The presence of the blocking moiety decreases the possibility of hydrolysis of siloxanes (as well as silanes). This provides greater stability to the resulting surface modifying treatment agent to water.

In an embodiment, the carrier fluid may further contain a non-emulsifier to prevent the possibility of the formation of an emulsion in-situ between any precipitated hydrocarbons and water as well as between oil and water. Such non-emulsifiers may reduce the stability of any emulsion being formed, enabling the separation of the two phases. Suitable non-emulsifiers may include of a blend of polyglycols in alcohol, polyethylene glycol (PEG), polyacrylamides, non-ionic surfactants such as alkylphenol ethoxylates (APEs) and fatty alcohol ethoxylates; anionic surfactants such as sulfonates and sulfosuccinate, organic acids, such as acetic acid and formic acid.

In an embodiment, the fluid may further contain an organic acid. This is especially the case in those instances where the fluid is to address scale deposition. Suitable organic acids include acetic acid, formic acid, citric acid, lactic acid, oxalic acid, acetohydroxamic acid (AHA), propionic acid, tartaric acid, succinic acid, adipic acid, glutaric acid as well as mixtures thereof. When used, the amount of organic acid in the carrier fluid is from about 0.01 to about 45, preferably from about 0.05 to about 30, weight percent.

### EXAMPLES

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

All percentages set forth in the Examples are given in terms of weight units except as may otherwise be indicated.
Example 1. A fluid (“Lotus Fluid”) was prepared containing 25% isopropyl alcohol, 55% ammonium chloride brine and ethylene glycol monobutyl ether (as mutual solvent). The fluid had a flash point of 96.8° F. (36° C.) compared to the flash point of isopropyl alcohol, 57° F. (13.9° C.). The Lotus Fluid was able to clean condensate as well as water blockages.
Example 2. Glass slides were etched with an organic acid to simulate a sandstone matrix. One of the glass slides was immersed into Lotus Fluid. A second glass was immersed into isopropyl alcohol

Water was then applied onto the two glass slides. FIG. 3 illustrates the formation of water droplet beads compared to the untreated portion (exposed only to isopropyl alcohol). The water droplet beads establish treatment alteration on the surface of the rock which provides more efficient fluid movement over a long term sustained production stream.

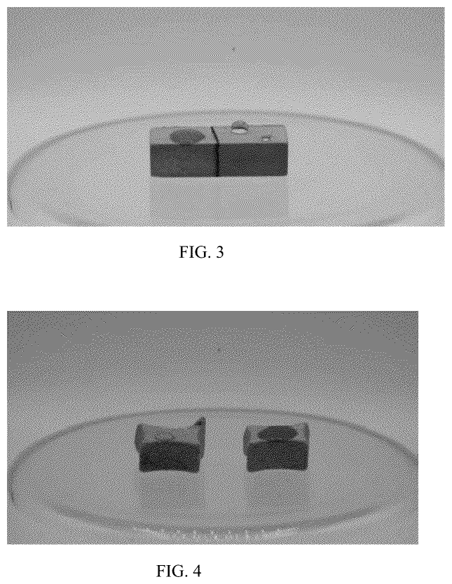

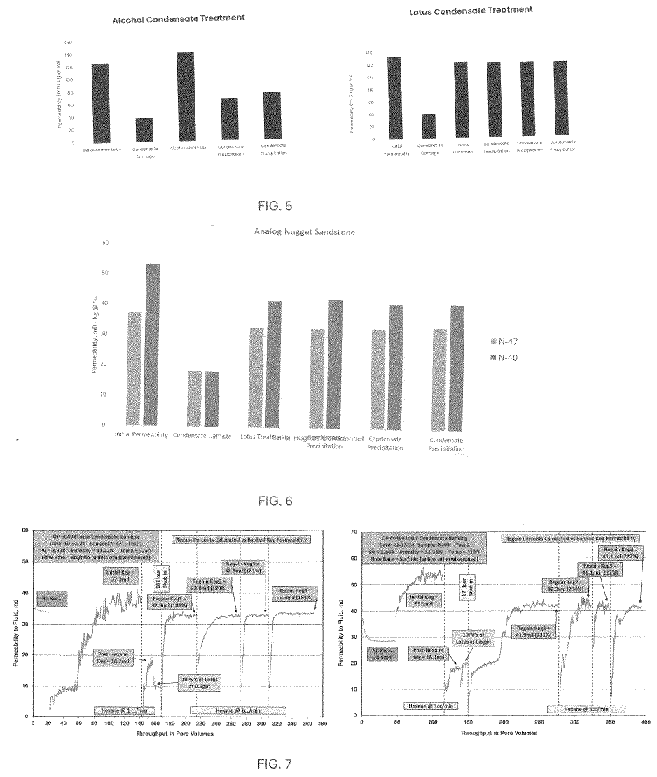

Instead of immersing glass slides into water, oil was applied onto the glass slides. FIG. 4 illustrates the formation of oil droplet beads when oil is applied to the coated sandstone surface. The treatment establishes more efficient fluid movement by producing hydrocarbon blockage for long term sustained production.
Example 3. Surface modified hydroxy containing silica nanoparticles were treated with a perfluorosilane/polysiloxane mixture at 40° C. and introduced to the fluids. The fluids were introduced into a cylindrical core plug (1 inch in diameter and 2 inches long) under pressure and permeability was measured using Darcy's Law. Permeability was measured as mD, kg @ Swi (gas permeability at irreducible water saturation). The results are shown in FIG. 3 which demonstrates the lasting effect of the Lotus Fluid when treating gas condensate banking versus only a temporary change with the isopropyl alcohol (comparative fluid). When the surface of the sandstone (rock) is treated with the Lotus Fluid, core flow testing shows clean-up of the damage. After the condensate was built and the condensate treated, formation damage was cleaned as shown by the increase in permeability. The presence of the surface modified hydroxy containing nanoparticles in the fluid demonstrated more of a long-lasting effect of treatment for hundreds of pore volume.
Example 4. The Lotus Fluid of Example 1 was subjected to testing with hexane as condensate. The results are shown in FIG. 5. Comparing a neat alcohol (99% IPA) based treatment to the Lotus treatment (Lotus in 99% IPA) showed they both had an effective initial treatment effect in removing the condensate and restoring permeability. Both tests cycled condensate and gas post treatment to recreate the condensation block. The alcohol treatment initial effect was good as it restored permeability but had no lasting effect because the condensate block was reestablished quickly in the first cycle as seen in the reduced permeability and restricted flow, which limited production. The Lotus treatment showed that initial effect was good in removing the condensate block and restoring permeability. Lotus has a lasting effect which was shown in the consistently stable permeability at nearly 100% of initial permeability. No change was observed after cycling condensate and gas multiple times, allowing flow to continue unimpeded.

### EMBODIMENTS

Embodiment 1. A method of restoring or increasing production of a well having been partially or completely blocked by contaminants, accumulated water or accumulated condensate, the method comprising:
A. pumping surface modified hydroxy containing nanoparticles in a carrier fluid into the well, wherein:
1. the carrier fluid comprising at least one of the following:
   a. an alcohol selected from the group consisting of methanol, ethanol, propyl alcohol, isopropyl alcohol, butanol, iso-butanol and mixtures thereof;
   b. a brine selected from the group consisting of sodium chloride, sodium bromide, potassium chloride, potassium bromide, ammonium chloride, ammonium bromide and mixtures thereof; and
   c. a mutual solvent;
2. the hydroxy containing nanoparticles are surface modified with a surface modifying treatment agent comprised of (i) an anchor selected from the group consisting of aluminum, silicon and a transition metal; and (ii) one or more hydrophobic and/or oleophobic moieties attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer or perfluoroalkylene ether; and
B. removing the blockage and increasing flow of fluids from a subterranean formation penetrated by the well.
Embodiment 2. The method of embodiment 1, wherein the surface modifying treatment agent is of the structure ZₘX(OR)ₙ wherein X is the anchor; each Z is the hydrophobic and/or oleophobic moieties; each R is independently selected from a branched or unbranched C₁-C₂₀ alkyl or aryl group; m+n is defined by the valence state of the anchor provided neither m nor n are zero.
Embodiment 3. The method of embodiment 2, wherein the hydrophobic and/or oleophobic group contains at least one terminal trifluoromethyl group.
Embodiment 4. A method of remediating a well penetrating a subterranean formation wherein flow of fluids from the formation to the well has been restricted or obstructed by contaminants, accumulated water or accumulated condensate in the well, the method comprising:
A. pumping surface modified hydroxy containing nanoparticles in a carrier fluid into the well wherein:
   1. the carrier fluid comprising at least one of the following:
      a. an alcohol selected from the group consisting of methanol, ethanol, propyl alcohol, isopropyl alcohol, butanol, iso-butanol and mixtures thereof;
      b. a brine consisting selected from the group consisting of sodium chloride, sodium bromide, potassium chloride, potassium bromide, ammonium chloride, ammonium bromide and mixtures thereof; and
      c. a mutual solvent;
   2. the surface modified hydroxy containing nanoparticles are hydroxy containing nanoparticles surface modified with a surface modifying treatment agent of the structure ZₘX(OR)ₙ wherein X is an anchor selected from the group consisting of aluminum, silicon and a transition metal; Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer, or perfluoroalkylene ether; each R being independently selected from a branched or unbranched C₁-C₂₀ alkyl or aryl group; m+n is defined by the valence state of the anchor provided neither m nor n are zero; and
B. attaching the surface modified hydroxy containing nanoparticles onto the surface of the formation wherein the hydrophobic and/or oleophobic functional groups are imparted away from the surface of the formation; and
C. removing the blockage and increasing flow of fluids from a subterranean formation penetrated by the well.
Embodiment 5. The method of any of embodiments 1 to 4, wherein the nanoparticles onto which one or more hydroxyl groups are attached are selected from the group consisting of silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, iron oxide, fullerenes, nanotubes, graphenes like nanographite, nanodots, nanorods, nanodiamonds, polysilsesquioxanes, antimony oxide, vanadium oxide, magnesium oxide, metal or metalloid carbides, and mixtures thereof.
Embodiment 6. The method of claim 5, wherein the nanoparticles onto which one or more hydroxyl groups are attached are selected from the group consisting of silica, silicic acid, aluminum oxides, aluminum hydroxides, aluminum hydroxyoxides, aluminosilicates, zirconium oxides, zirconium hydroxides, zirconium hydroxyoxides and mixtures thereof.
Embodiment 7. A method of restoring or increasing production of a well having flowpaths partially or completely obstructed or blocked by contaminants, accumulated water or accumulated condensate, the method comprising:
A. pumping nanoparticles in a carrier fluid into the well wherein:
   1. the carrier fluid comprises at least one of the following:
      a. an alcohol selected from the group consisting of methanol, ethanol, propyl alcohol, isopropyl alcohol, butanol, iso-butanol and mixtures thereof;
      b. a brine consisting of sodium chloride, sodium bromide, potassium chloride, potassium bromide, ammonium chloride, ammonium bromide and mixture thereof; and
      c. a mutual solvent;
   2. the nanoparticles, onto which one or more hydroxyl groups are attached, are selected from the group consisting of silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, iron oxide, fullerenes, nanoclays, nanotubes, graphenes like nanographite, nanodots, nanorods, nanodiamonds, polysilsesquioxanes, antimony oxide, vanadium oxide, magnesium oxide, metal or metalloid carbides, and mixtures thereof; and
   3. the nanoparticles have one or more hydroxyl groups and are further surface modified with a surface modifying treatment agent of the structure ZₘX(OR)ₙ wherein X is an anchor selected from the group consisting of aluminum, silicon and a transition metal; Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer or perfluoroalkylene ether; each R being independently selected from a branched or unbranched C₁-C₂₀ alkyl or aryl group; m+n is defined by the valence state of the anchor provided neither m nor n are zero; and
B. attaching the surface modified hydroxy containing nanoparticles onto a surface of a subterranean formation penetrated by the well, wherein the hydrophobic and/or oleophobic functional groups are imparted away from a surface of a subterranean formation penetrated by the well; and
C. removing the blockage and increasing flow of fluids from the subterranean formation to the well.
Embodiment 8. The method of any of embodiments 2 to 6, wherein the surface modifying treatment agent is altered by substitution of at least one of the —OR groups with a substituted or unsubstituted C₁-C₈ modified glycol having the hydroxy group on one end of the glycol modified with —OB, wherein B is C₁-C₂₀ branched or unbranched alkyl group or an aryl group.
Embodiment 9. The method of any of embodiments 1 to 8, wherein the contaminants are scales.
Embodiment 10. The method of any of embodiments 1 to 9, wherein the mutual solvent is selected from the group consisting of glycol ethers or esters, tetrahydrofuran, dioxane, dimethylformamide, dimethylsulfoxide and mixtures thereof.
Embodiment 11. The method of embodiment 10, wherein the glycol ether is ethyleneglycolmonobutyl ether (EGMBE), dipropylene glycol monomethyl ether and mixtures thereof.
Embodiment 12. The method of any of embodiments 1 to 11, wherein the fluid further comprises a non-emulsifier.
Embodiment 13. The method of any of embodiments 1 to 12, wherein the carrier fluid further comprises an organic acid selected from the group constating of acetic acid, formic acid, citric acid, lactic acid, oxalic acid, acetohydroxamic acid (AHA), propionic acid, tartaric acid, succinic acid, adipic acid, glutaric acid and mixtures thereof.
Embodiment 14. The method of embodiment 13, wherein the contaminants are scales.
Embodiment 15. The method of any of embodiments 1 to 14, wherein the amount of salt in the brine is about 2 to about 3 weight percent.
Embodiment 16. The method of any of embodiments 1 to 15, wherein the amount of brine in the carrier fluid is from about 40 to about 60 weight percent.
Embodiment 17. The method of any of embodiments 1 to 16, wherein the flash point of the fluid is from about 90° F. to about 120° F.
Embodiment 18. The method of any of embodiments 1 to 17, wherein the formation is sandstone.
Embodiment 19. The method of any of embodiments 1 to 17, wherein the formation is a carbonate formation.
Embodiment 20. The method of any of embodiments 1 to 19, wherein one or more hydroxyl groups on the surface modified hydroxy containing nanoparticles are directly attached on the surface of the subterranean formation.
Embodiment 21. The method of any of embodiments 1 to 20, further comprising aligning the surface modifying treatment agent to the subterranean formation such that the hydrophobic and/or oleophobic moieties are directed away from the surface of the formation.
Embodiment 22. The method of any of embodiments 1 to 21, wherein the hydrophobic and/or oleophobic group contains at least one terminal trifluoromethyl group.
Embodiment 23. The method of any of embodiments 1 to 22, wherein the hydrophobic and/or oleophobic group is a C₃-C₄₀ fluorinated alkyl, fluorinated aryl group or a fluorinated ethylenically unsaturated monomer.
Embodiment 24. The method of any of embodiments 1 to 23, wherein the carrier fluid has at least one alcohol, at least one brine and at least one mutual solvent.
Embodiment 25. The method of claim 24, wherein the at least one alcohol is isopropyl alcohol, the at least one brine is ammonium chloride and the at least one mutual solvent is ethylene glycol monobutyl ether.
Embodiment 26. The method of any of embodiments 1 to 25, wherein at least one of the following conditions prevail:
(a) the surface modified hydroxy containing nanoparticles increase the relative permeability of the formation to oil/gas with respect to water, oil and/or condensate thus preventing water banking behind the formation surface;
(b) the well is a retrograde condensate gas reservoir, and the surface modified hydroxy containing nanoparticles minimize condensates within the reservoir while maintaining the permeability of the reservoir; or
(c) the surface modified hydroxy containing nanoparticles control water saturation in the pores of the near wellbore region of the subterranean formation.

What is claimed is:

1. A method of restoring or increasing production of a well having been partially or completely blocked by contaminants, accumulated water or accumulated condensate, the method comprising:
A. pumping surface modified hydroxy containing nanoparticles in a carrier fluid into the well, wherein:
1. the carrier fluid comprising at least one of the following:
a. an alcohol selected from the group consisting of methanol, ethanol, propyl alcohol, isopropyl alcohol, butanol, iso-butanol and mixtures thereof;
b. a brine selected from the group consisting of sodium chloride, sodium bromide, potassium chloride, potassium bromide, ammonium chloride, ammonium bromide and mixtures thereof; and
c. a mutual solvent;
2. the hydroxy containing nanoparticles are surface modified with a surface modifying treatment agent comprised of (i) an anchor selected from the group consisting of aluminum, silicon and a transition metal; and (ii) one or more hydrophobic and/or oleophobic moieties attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer or perfluoroalkylene ether; and
B. removing the blockage and increasing flow of fluids from a subterranean formation penetrated by the well.

2. The method of claim 1, wherein the surface modifying treatment agent is of the structure ZₘX(OR)ₙ wherein X is the anchor; each Z is the hydrophobic and/or oleophobic moieties; each R is independently selected from a branched or unbranched C₁-C₂₀ alkyl or aryl group; m+n is defined by the valence state of the anchor provided neither m nor n are zero.

3. The method of claim 2, wherein the hydrophobic and/or oleophobic group contains at least one terminal trifluoromethyl group.

4. The method of claim 1, wherein the nanoparticles onto which one or more hydroxyl groups are attached are selected from the group consisting of silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, iron oxide, fullerenes, nanotubes, graphenes like nanographite, nanodots, nanorods, nanodiamonds, polysilsesquioxanes, antimony oxide, vanadium oxide, magnesium oxide, metal or metalloid carbides, and mixtures thereof.

5. The method of claim 2, wherein the surface modifying treatment agent is altered by substitution of at least one of the —OR groups with a substituted or unsubstituted C₁-C₈ modified glycol having the hydroxy group on one end of the glycol modified with —OB, wherein B is C₁-C₂₀ branched or unbranched alkyl group or an aryl group.

6. The method of claim 1, wherein at least one of the following is true:
(a) the contaminants are scales;
(b) the mutual solvent is selected from the group consisting of glycol ethers or esters, tetrahydrofuran, dioxane, dimethylformamide, dimethylsulfoxide and mixtures thereof;
(c) the carrier fluid further comprises an organic acid selected from the group constating of acetic acid, formic acid, citric acid, lactic acid, oxalic acid, acetohydroxamic acid (AHA), propionic acid, tartaric acid, succinic acid, adipic acid, glutaric acid and mixtures thereof;
(d) the amount of salt in the brine is about 2 to about 3 weight percent;
(e) the amount of brine in the carrier fluid is from about 40 to about 60 weight percent;
(f) the flash point of the fluid is from about 90° F. to about 120° F. . . . ; or
(g) the formation is sandstone or a carbonate formation.

7. The method of claim 1, wherein one or more hydroxyl groups on the surface modified hydroxy containing nanoparticles are directly attached on the surface of the subterranean formation.

8. The method of claim 1, further comprising aligning the surface modifying treatment agent to the subterranean formation such that the hydrophobic and/or oleophobic moieties are directed away from the surface of the formation.

9. The method of claim 1, wherein the hydrophobic and/or oleophobic group is a C₃-C₄₀ fluorinated alkyl, fluorinated aryl group or a fluorinated ethylenically unsaturated monomer.

10. The method of claim 1, wherein the carrier fluid has at least one alcohol, at least one brine and at least one mutual solvent.

11. The method of claim 10, wherein the at least one alcohol is isopropyl alcohol, the at least one brine is ammonium chloride and the at least one mutual solvent is ethylene glycol monobutyl ether.

12. The method of claim 1, wherein at least one of the following conditions prevail:
(a) the surface modified hydroxy containing nanoparticles increase the relative permeability of the formation to oil/gas with respect to water, oil and/or gas condensate thus preventing water banking behind the formation surface;
(b) the well is a retrograde condensate gas reservoir, and the surface modified hydroxy containing nanoparticles minimize condensates within the reservoir while maintaining the permeability of the reservoir; or
(c) the surface modified hydroxy containing nanoparticles control water saturation in the pores of the near wellbore region of the subterranean formation.

13. A method of remediating a well penetrating a subterranean formation wherein flow of fluids from the formation to the well has been restricted or obstructed by contaminants, accumulated water or accumulated condensate in the well, the method comprising:
A. pumping surface modified hydroxy containing nanoparticles in a carrier fluid into the well wherein:
1. the carrier fluid comprising at least one of the following:
a. an alcohol selected from the group consisting of methanol, ethanol, propyl alcohol, isopropyl alcohol, butanol, iso-butanol and mixtures thereof;
b. a brine consisting selected from the group consisting of sodium chloride, sodium bromide, potassium chloride, potassium bromide, ammonium chloride, ammonium bromide and mixtures thereof, and
c. a mutual solvent;
2. the surface modified hydroxy containing nanoparticles are hydroxy containing nanoparticles surface modified with a surface modifying treatment agent of the structure ZₘX(OR)ₙ wherein X is an anchor selected from the group consisting of aluminum, silicon and a transition metal; Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer, or perfluoroalkylene ether; each R being independently selected from a branched or unbranched C₁-C₂₀ alkyl or aryl group; m+n is defined by the valence state of the anchor provided neither m nor n are zero; and
B. attaching the surface modified hydroxy containing nanoparticles onto the surface of the formation wherein the hydrophobic and/or oleophobic functional groups are imparted away from the surface of the formation; and
C. removing the blockage and increasing flow of fluids from a subterranean formation penetrated by the well.

14. The method of claim 13, wherein the nanoparticles onto which one or more hydroxyl groups are attached are selected from the group consisting of silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, iron oxide, fullerenes, nanotubes, graphenes like nanographite, nanodots, nanorods, nanodiamonds, polysilsesquioxanes, antimony oxide, vanadium oxide, magnesium oxide, metal or metalloid carbides, and mixtures thereof.

15. The method of claim 13, wherein the surface modifying treatment agent is altered by substitution of at least one of the —OR groups with a substituted or unsubstituted C₁-C₈ modified glycol having the hydroxy group on one end of the glycol modified with —OB, wherein B is C₁-C₂₀ branched or unbranched alkyl group or an aryl group.

16. The method of claim 1, wherein one or more hydroxyl groups on the surface modified hydroxy containing nanoparticles are directly attached on the surface of the subterranean formation and/or further comprising aligning the surface modifying treatment agent to the subterranean formation such that the hydrophobic and/or oleophobic moieties are directed away from the surface of the formation.

17. The method of claim 13, wherein at least one of the following conditions prevail:
(a) the surface modified hydroxy containing nanoparticles increase the relative permeability of the formation to oil/gas with respect to water, oil and/or gas condensate thus preventing water banking behind the formation surface;
(b) the well is a retrograde condensate gas reservoir, and the surface modified hydroxy containing nanoparticles minimize condensates within the reservoir while maintaining the permeability of the reservoir; or
(c) the surface modified hydroxy containing nanoparticles control water saturation in the pores of the near wellbore region of the subterranean formation.

18. A method of restoring or increasing production of a well having flowpaths partially or completely obstructed or blocked by contaminants, accumulated water or accumulated condensate, the method comprising:
A. pumping nanoparticles in a carrier fluid into the well wherein:
1. the carrier fluid comprises at least one of the following:
a. an alcohol selected from the group consisting of methanol, ethanol, propyl alcohol, isopropyl alcohol, butanol, iso-butanol and mixtures thereof;
b. a brine consisting of sodium chloride, sodium bromide, potassium chloride, potassium bromide, ammonium chloride, ammonium bromide and mixture thereof; and
c. a mutual solvent;
2. the nanoparticles, onto which one or more hydroxyl groups are attached, are selected from the group consisting of silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, iron oxide, fullerenes, nanoclays, nanotubes, graphenes like nanographite, nanodots, nanorods, nanodiamonds, polysilsesquioxanes, antimony oxide, vanadium oxide, magnesium oxide, metal or metalloid carbides, and mixtures thereof; and
3. the nanoparticles have one or more hydroxyl groups and are further surface modified with a surface modifying treatment agent of the structure ZₘX(OR)ₙ wherein X is an anchor selected from the group consisting of aluminum, silicon and a transition metal; Z is a hydrophobic and/or oleophobic moiety attached to the anchor, each moiety being independently selected from a branched or unbranched C₃-C₄₀ alkyl, C₃-C₄₀ aryl, C₃-C₄₀ fluorinated alkyl, C₃-C₄₀ fluorinated aryl, C₃-C₄₀ fluorinated ethylenically unsaturated monomer or perfluoroalkylene ether; each R being independently selected from a branched or unbranched C₁-C₂₀ alkyl or aryl group; m+n is defined by the valence state of the anchor provided neither m nor n are zero; and
B. attaching the surface modified hydroxy containing nanoparticles onto a surface of a subterranean formation penetrated by the well, wherein the hydrophobic and/or oleophobic functional groups are imparted away from a surface of a subterranean formation penetrated by the well; and
C. removing the blockage and increasing flow of fluids from the subterranean formation to the well.

19. The method of claim 18, wherein one or more hydroxyl groups on the surface modified hydroxy containing nanoparticles are directly attached on the surface of the subterranean formation and/or further comprising aligning the surface modifying treatment agent to the subterranean formation such that the hydrophobic and/or oleophobic moieties are directed away from the surface of the formation.

20. The method of claim 18, wherein the at least one alcohol is isopropyl alcohol, the at least one brine is ammonium chloride and the at least one mutual solvent is ethylene glycol monobutyl ether.
